(19) United States
(12) Patent Application Publication
(10) Pub. No.: US 2009/0078643 A1
(43) Pub. Date: Mar. 26, 2009

(54) Low off-gassing polyurethanes

(76) Inventors: Elviro James Mastrobuono, Franklin, MA (US); John C. Gaudreau, Chepachet, RI (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/920,036

(22) PCT Filed: May 22, 2006
(86) PCT No.: PCT/US2006/019803

§ 371 Date: Nov. 7, 2007

Related U.S. Application Data
(60) Provisional application No. 60/684,193, filed on May 23, 2005.

(51) Int. Cl. B01D 29/00; C08L 75/04

(52) U.S. Cl. 210/495; 524/590; 521/170; 521/154

(57) ABSTRACT

A low out-gassing polyurethane is described for use in applications where contaminants must be kept to very low levels, such as during lithography. In particular, the polyurethane is essentially free of silicon-containing species, which present particular contamination problems in the context of electronic device manufacturing. The polyurethane may be utilized as a potting material in filter assemblies, or in other contexts within the environment of electronics manufacturing. Testing of the novel polyurethane formulation shows the off-gassing characteristics to be much lower than commercially available potting materials made from polyethylene.

### RELATED APPLICATIONS

This application claims the benefit of U.S. Provisional Application No. 60/684,193, filed May 23, 2005, the entire teachings of which are incorporated herein by reference.

### BACKGROUND OF THE INVENTION

Electronic component manufacturing and processing increasingly requires that manufacturing steps be performed in progressively cleaner environments as feature sizes are driven down by performance requirements. The presence of various types of contaminants, such as silicon-containing species (e.g., siloxanes such as hexamethyl disiloxane (HMDSO); silanes; silazanes such as hexamethyldisilazane (HMDS); silanols), molecular organics (e.g., hydrocarbons, halogenated hydrocarbons, phthalates, butylated hydroxytoluene, chlorines), volatile bases (e.g., ammonia, amides, amines), and volatile acids (SO_{X}, NO_{X}, hydrogen halides, sulfuric acid, sulfonic acid, carboxylic acids), adversely affect the ability of manufacturers to produce electronic components with desired performance characteristics.

### SUMMARY OF THE INVENTION

Embodiments of the invention are directed to novel low off-gassing polyurethanes. In one embodiment of the invention, a low off-gassing polyurethane comprises a polyurethane substrate, and additive(s) being essentially free of silicon-containing contaminant. The polyurethane substrate may be foamed or formulated to emit one or more silicon-containing contaminants at a rate below about 0.0001 μg/gm/min when the substrate is subjected to a temperature of about 50° C. for about 30 minutes at about atmospheric pressure. The low gassing polyurethane may also comprise carbon black.

Low off-gassing polyurethanes are characterized as emitting contaminants at a low enough level for the polyurethanes to be used in an environment for electronics manufacturing without detrimentally impacting the quality of the manufactured component or other portions of the process. In particular, low off-gassing may be directed to particular applications such as conventional lithography and/or liquid immersion lithography.

Another embodiment of the invention is directed to a potting material comprising any of the polyurethane substrates described herein in which the polyurethane is foamed.

In another embodiment of the invention, the potting material of the last embodiment is utilized in a filter unit comprising a filter membrane, a filter frame, and the potting material. The potting material attaches the filter unit to the filter membrane.

Testing of common polyethylene based potting materials, as discussed herein, shows that commercially available products do not achieve the low off-gassing characteristics that are desired by some electronic manufacturers. Thus, a need exists to produce a polymeric material with low off-gassing characteristics for use in particular electronic manufacturing environments. In particular, low off-gassing of silicon-containing species and contaminants is especially desired in applications such as producing potting materials and substrates for use in dry and liquid immersion lithography (LIL) environments.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A depicts a gravity dispensing system using a pump metering system for producing low out-gassing polyurethane, consistent with an embodiment of the invention.

FIG. 1B depicts a dispenser unit for use with the gravity dispensing system of FIG. 1A, in accord with an embodiment of the invention.

FIG. 1C depicts a cross sectional view of a disposable mix head for use with the dispenser unit of FIG. 1B, in accord with an embodiment of the invention.

FIG. 2 presents a schematic of an apparatus used to detect the off-gassing of filter units including the off-gassing of potting materials in accord with an embodiment of the invention.

FIG. 3A presents a graph of the emission from a GC/MS column analysis of downstream off-gassing from a E3000 filter unit after 0 to 4 hours of exposure to 200 ft³/min of essentially clean air, the detection configured to detect high boilers.

FIG. 3B presents a graph of the emission from a GC/MS column analysis of downstream off-gassing from a E3000 filter unit after 24 hours of exposure to 200 ft³/min of essentially clean air, the detection configured to detect high boilers.

FIG. 4 presents a graph of the emission from a GC/MS column analysis of desorption of species from a sample of a commercially available polyethylene used as a potting material when subjected to a temperature of about 50° C. for about 30 minutes, the detection configured to detect high boilers.

FIG. 5 presents a graph of the emission from a GC/MS column analysis of downstream off-gassing from a filter unit utilizing a commercially available polyethylene potting material after 24 hours of exposure corresponding with the results shown in Table 1, the detection configured to detect high boilers.

FIG. 6 presents four graphs of the GC/MS column analyses of desorption of species from samples of commercially available polyethylenes used as a potting material when subjected to a temperature of about 50° C. for about 30 minutes.

FIG. 7 presents four additional graphs of the GC/MS column analyses of desorption of species from additional samples of commercially available polyethylenes used as a potting material when subjected to a temperature of about 50° C. for about 30 minutes.

FIG. 8A presents a graph of the emission from a GC/MS column analysis of downstream off-gassing from a filter unit utilizing a commercially available polyethylene potting material, the detection configured to detect high boilers.

FIG. 8B presents a graph of the emission from a GC/MS column analysis of downstream off-gassing from a filter unit utilizing sample S1 as a potting material, the detection configured to detect high boilers.

### DETAILED DESCRIPTION OF THE INVENTION

Embodiments of the invention utilize a low off-gassing polyurethane comprising a polyurethane substrate and additive that is essentially free of silicon-containing contaminants or species. Such silicon-containing species or contaminants include siloxanes such as hexamethyl disiloxane (HMDSO) and hexamethylcyclotrisiloxane; silanes such as isobutoxytrimethyl silane and trimethyl silane (TMS); silazanes such as hexamethyldisilazane (HMDS); silanols; and silicones. In addition, the polyurethane substrate may also possess low off-gassing of other contaminants such as aliphatic hydrocarbons; BHT; chlorobenzene, other substituted and unsubstituted phenols; phthalates such as DOP, DEP, and DBP; and volatile acids and bases.

Additives are any composition or compound which is added to the polyurethane polymer to impart desired properties to the polyurethane. Additives include but are not limited to leveling agents, foaming agents, antioxidants, agents that regulate or control flow or viscosity, plasticizers, flame retardants, pigments, fillers. For purposes of this invention, an additive is selected based upon its low off-gassing of silicon species or contaminants. Reduction or elimination of silicon-containing species in an additive is desirable to produce a low off-gassing polyurethane of the invention.

In particular, the low off-gassing polyurethanes are characterized by particular low off-gassing rates, i.e., the reduced production of particular undesired species or contaminants relative to other polymer substrates or polyurethane formulations. The low off-gassing characteristics of the polyurethane are particularly advantageous when the polyurethane is utilized in applications requiring extremely low contamination levels, such as lithography and other electronics manufacturing processes.

One particular application is in the area of potting materials. Potting materials act as a sealant to fill gaps or adhere two or more pieces together, and are used in sensitive areas of electronic components or electronic equipment manufacturing. For example, in the production of filter units for cleaning gases in electronic device production environments, potting materials such as polyethylene and polyurethanes are typically used as an adhesive to bind the filter membrane to a aluminum filter frame. Since potting materials are often composed of an organic-based substrate, off-gassing of organics and other species resident in and on the substrate presents a major source of contamination in electronics manufacturing. Thus, low off-gassing potting materials are able to act as sealers and/or adhesives in electronic applications without producing contaminants that are detrimental to the environments in which they are exposed.

In another particular application, the emerging area of liquid immersion lithography (LIL) drives the need for environments that are relatively free of particular contaminants. LIL involves performing lithography in a liquid environment where the index of refraction of the liquid is greater than one (e.g., for water n=1.44 at 193 nm). LIL potentially enables greater resolution of feature sizes and better depth of focus for larger feature sizes. The high transmission of liquids such as water, however, causes a small amount of any contaminant to dominate absorbance of the radiation. Decreasing the level of contaminants, especially silicon-containing species, is extremely important if LIL is to attain commercial success. Thus, in some embodiments of the invention, low off-gassing substrates emit contaminants at a level acceptable to perform LIL.

More specifically, for example, manufacturers of electronic devices require processes operate with a condensable organic level below about 0.9 μg/m³, and more preferably below about 0.35 μg/m³. As well, keeping silicon-containing species below about 0.1 μg/m³, and individual amounts of particular phthalates (e.g., dioctyl phthalate (DOP), dibutyl phthalate (DBP), diethyl phthalate (DEP)) butylated hydroxytoluene (BHT), and chlorine organics below about 0.2 μg/m³ is of great importance. Furthermore, keeping volatile bases below about 0.2 μg/m³, preferably below about 0.07 μg/m³, and volatile acids below a level ranging from about 0.4 μm³ to about 0.03 μg/m³ is also important.

In one embodiment, the polyurethane releases less than about 0.0001 μg of one or more silicon-containing species or contaminants per gram of polyurethane per minute (μg/gm/min) when the polyurethane is exposed to a temperature of about 50° C. for about 30 minutes. These quantities of off-gassing may be determined using desorption tests that analyze the species or contaminants using GC/MS as described herein. The silicon-containing species include, but are not limited to, those particular species described herein. In another embodiment, the polyurethane releases less than about 0.0018 μg/gm/min BHT when exposed to a temperature of about 50° C. for about 30 minutes. In other embodiments of the invention, the polyurethane releases less than about 0.0001 μg/gm/min of one or more low molecular weight aliphatic hydrocarbons (molecular weight less than tetradecane) and/or phthalates when exposed to a temperature of about 50° C. for about 30 minutes. In another embodiment, the polyurethane releases less than about 0.0005 μg/gm/min chlorobenzene when exposed to a temperature of about 50° C. for about 30 minutes. In particular for these embodiments, off-gassing typically occurs at a pressure that is substantially ambient, i.e., about one atmosphere.

In a related embodiment, the polyurethane further comprises carbon black. The polyurethane substrate may also be foamed. Carbon black is used to eliminate the discoloration of aged polyurethane in the absence of BHT, the BHT typically used as an antioxidant to prevent yellowing of the substrate. Carbon black may also interact with the substrate to help enhance the low off-gassing properties of the polyurethane. Foaming of the substrate helps decrease the amount of polyurethane required for a particular application, thereby decreasing material costs. Solid polyurethane has a density of about 1.4 g/cm³, while the foamed polyurethane's density is about 0.15 g/cm³. Foaming may also impart particular mechanical properties to the polyurethane (e.g., lower density) that may be advantageous in particular applications.

The polyurethane substrates utilized with embodiments of the invention are formed by reacting a diisocyanate:

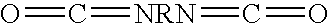

with a diol:

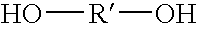

to yield the polyurethane

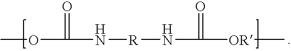

The reaction is exothermic and quite rapid, completing in about two minutes; the finished material may be handled in about five minutes.

Foaming may be achieved in various manners. Preferably, some water is incorporated with the polyol. Water reacting with the diisocyanate creates an amine and carbon dioxide, the latter acting to form the material. The amine reacts with further isocyanate to form a substituted urea, which again reacts with isocyanate to form an imidocarbonic diamide (or biuret). Thus, by adding excess diisocyanate, one can control the formation of this side product, which tends to harden the polymer network and increase the crosslinking.

Alternatively, a fluorocarbon is mixed with the reactants. The exotherm produced by the reaction causes the fluorocarbon to vaporize and act as a blowing agent to produce the foam. Nitrogen can also be used with the reactants to control or regulate foaming.

Low off-gassing polyurethanes are achieved by removal of particular additives that are typically and ubiquitously incorporated with the reaction mixture to control particular properties of the end polyurethane product. For example, a number of silicon-containing species are incorporated in small amounts in urethane substrates. Trace amounts of HMEDSO are utilized with fumed silica to control the viscosity of the reaction mixture. As well, silicones are added to allow for surface leveling of the formed substrate, to act as an antifoaming agent, and to improve consistency of the substrates cell structure upon foaming. Thus, eliminating the presence of these components in the polyurethane formulation allows the substrate to achieve the low off-gassing characteristics that are desired.

Other chemical species of a non-silicon nature are also introduced into polyurethane formulations, adversely impacting the off-gassing properties of the substrate. Polyurethane manufacturers include BHT in their polyurethane formulations as an antioxidant to prevent discoloration and yellowing of the material with aging. Incorporation of carbon black with the formulation can help alleviate this aesthetic quality to the extent that such a property is important. Phthalates are also commonly added to polyurethane formulations as plasticizers to lower the glass-transition temperature of the polymeric substrate, increasing flexibility of the network. Other additives that may adversely affect off-gassing properties include flame retardants (including halogen compounds), pigments (organic additives), and other fillers.

Thus, embodiments of the invention utilize a polyurethane substrate formed from a formulation that is essentially free of silicon-containing species and contaminants. Other embodiments involve polyurethane formulations that are essentially free of other non-silicon-containing species (e.g., BHT, phthalates, and chemical species such as hydrocarbons and volatile acids and bases as discussed herein). This can be achieved by removing or eliminating silicone-containing species that can produce off-gas contaminants from additives that are admixed with the polyurethane polymer, as discussed above. It is not necessary to remove silicone species that are stably retained by polyurethane and would not off-gas, such as polymers having silicone moieties.

The particular nature of R and R′ in the reactants or formed polyurethane substrate does not limit the scope of the invention. Thus, specific polyurethanes that are formed from reacting toluene diisocyanate (the 2,4 or the 2,6 isomer), isophorone diisocyanate, diphenylmethane 4,4′ diisocyanate, naphthalene 1,5 diisocyanate, hexamethylene diisocyanate, or blends thereof. Diols of various types may also be used, including polyethers and polyesters. As well, a combination of polyol (having two or more hydroxide groups) and isocyanate can also be used to form the polyurethane. Indeed, the range of polyurethane formulations known to those of ordinary skill in the art can be utilized so long as the presence of undesired off-gassing components is not present in the formulation or completed substrate product. Undesired off-gassing characteristics of particular polyurethanes are identifiable using the experimental techniques discussed herein, i.e., desorption and off-gassing filter unit testing.

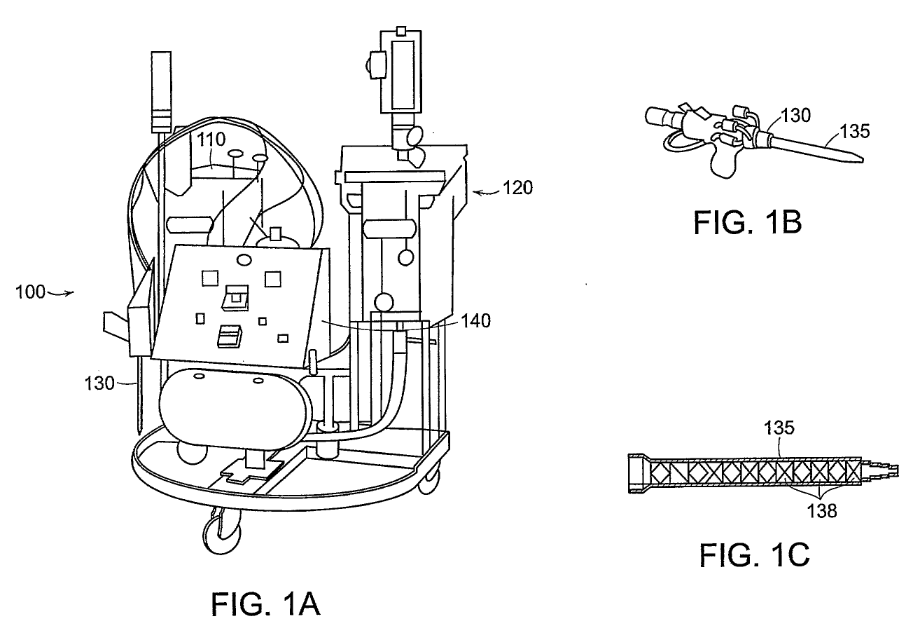

Formation of the low gassing polyurethane is achieved through a gravity dispensing system (Ashby Cross Company Inc.) 100 depicted in FIG. 1A which uses gear pump metering. Each component of the formulation is held in a drum 110, 120 and gravity fed into the metering system 140. The system includes a drum ram pump dispenser and a standard drum pump. Gravity feeding avoids the use of pumps that require lubricants that act as potential contaminants. Gear pump metering, as opposed to piston metering, is utilized to control flow of the reactants, again eliminating the need of potentially contaminating lubricants. Alternatively, a pump fed system may also be utilized. The components are dynamically mixed in a dispenser unit 130 that contains a disposable mix head 135, as depicted in FIGS. 1B and 1C. As shown in the cross-section of the disposable mix head 135 in FIG. 1C, the flow interrupting structures 138 promote mixing of the isocyanate and polyol reactants.

Low off-gassing polyurethanes are utilized in a number of other embodiments of the invention. In one embodiment, a potting material comprises a low off-gassing polyurethane consistent with any of the polyurethane compositions described herein. Another embodiment of the invention is directed to a filter unit comprising a filter membrane; a filter frame (e.g., constructed of aluminum); and a potting material used to attach the filter membrane to the filter frame. Though filter frames may typically refer to the production of air filters, other embodiments may utilize a filter housing in place of the frame in which the housing can be adapted for various types of fluid streams (liquid or gas). The potting material comprises a low off-gassing polyurethane consistent with any of the polyurethane compositions described herein. The low off-gassing polyurethane substrate limits off-gassing of contaminants, such as silicon-containing species and other contaminants, to help keep electronic manufacturing environments clean. Other embodiments of the invention utilize the polyurethane substrate embodiments described herein in other applications such as LIL environments to limit silicon-containing contamination.

Experiments were performed on a number of potting materials, commercially available and newly synthesized, to test their off-gassing characteristics. Two different types of tests were carried out on the various potting materials. Tests were all conducted at about atmospheric pressure.

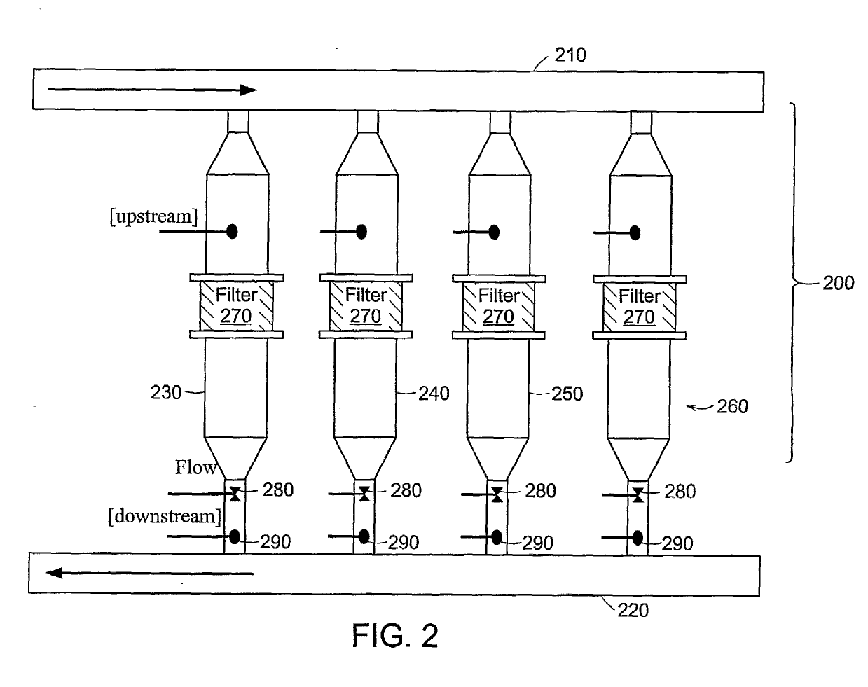

One set of tests were conducted to determine the off-gassing of actual filter units (herein “off-gassing filter test units”) using the apparatus 200 shown in FIG. 2. An input gas conduit 210 carries essentially clean air. The input gas conduit 210 is connected to the output gas conduit 220 by four parallel filter tunnels 230, 240, 250, 260, each loaded with an individual filter unit 270. Valves 280 in each of the filter tunnels 230, 240, 250, 260 may be opened or closed to control the path of gas from the input conduit 210 to the output conduit 220. For example, three of the four valves may be closed, and the remaining opened, to test the off-gassing characteristics of the filter unit 270 in the open valve filter tunnel. Gas flow through a filter tunnel is controlled using the valve. Alternatively, more than one filter tunnel may have air flowing there through, the respective valve being adjusted to determine the air flow in the respective filter tunnel. Sample ports 290 allow downstream sampling of the air after contact with the filter units 270. The sampled air is analyzed using a GC/MS to determine total and individual contaminant levels in terms of concentration (μg/m³) over various times. The sampler and GC/MS are wet up in two different detection configurations to capture two molecular weight groupings of contaminant species: the high boiler detection arrangement is configured to detect species with molecular weights greater than about C₆ to C₈ (around toluene); and the low boiler detection arrangement is configured to detect species having a molecular weight less than about C₆ to C₈. The low boiler detection arrangement utilizes a carbo-trap as a sampler, while the high boiler arrangement uses a Tenex tube. The GC/MS is also specifically calibrated depending upon whether high or low boilers are being emphasized during detection.

A second set of tests were conducted by performing direct desorption from samples of potting material (herein “desorption test”). Samples of potting material, about 0.2 mg, were exposed to an environment of 50° C. for 30 minutes. A Perkin-Elmer Turbomatrix™ sampler was used to collect any desorbed materials from the heated potting material. Desorbing of the secondary trap was conducted at 300° C. Analysis of the desorbed species from the secondary trap was performed using a Perkin-Elmer GC-MS, operating using a temperature ramp from 50° C. to 320° C. on a DB5 column. The amount of species captured is normalized by the amount of potting material sampled and the time of exposure for the potting material. Thus, the desorption result is given in μg of contaminants per gram of material sampled per time of sampling (μg/gm/min). The sampling and GC/MS are again adjusted to capture two molecular weight groupings of contaminant species: the high boiler detection arrangement is configured to detect species with molecular weights greater than about C₆ to C₈ (around toluene); and the low boiler detection arrangement is configured to detect species having a molecular weight less than about C₆ to C₈.

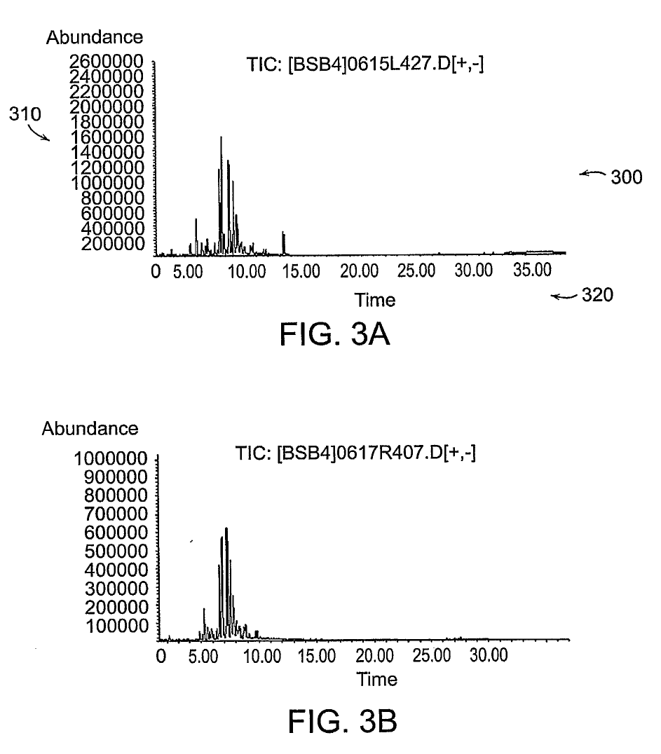

Using the off-gassing filter units test configured for high boiler species, filter units from an E3000 model filter unit produced by Extraction Systems, Inc. (now Entegris Corporation, Chaska, Minn.) were tested. Flow through the filter tunnel was approximately constant at about 200 ft³/min. A graph representing the contaminants identified by GC/MS is depicted in FIG. 3A. The graph 300 shows the relative abundance 310 of a species emitted at a particular time 320 from the GC/MS adsorption column. The time is also known as the retention time. Particular retention times may be correlated with a particular species. Toluene or hexadecane is utilized as a standard for calibrating the GC/MS retention times. The graph 300 shows the result of air sampling between 0 to 4 hours after air has been flowing through the off-gassing filter units test apparatus. Integration of the signal yields a total organic carbon output of about 54 μg/m³. After 24 hours of run time, the downstream concentration of contaminants is still significant as shown in FIG. 3B, the total integrated organic contamination being about 26 μg/m³.

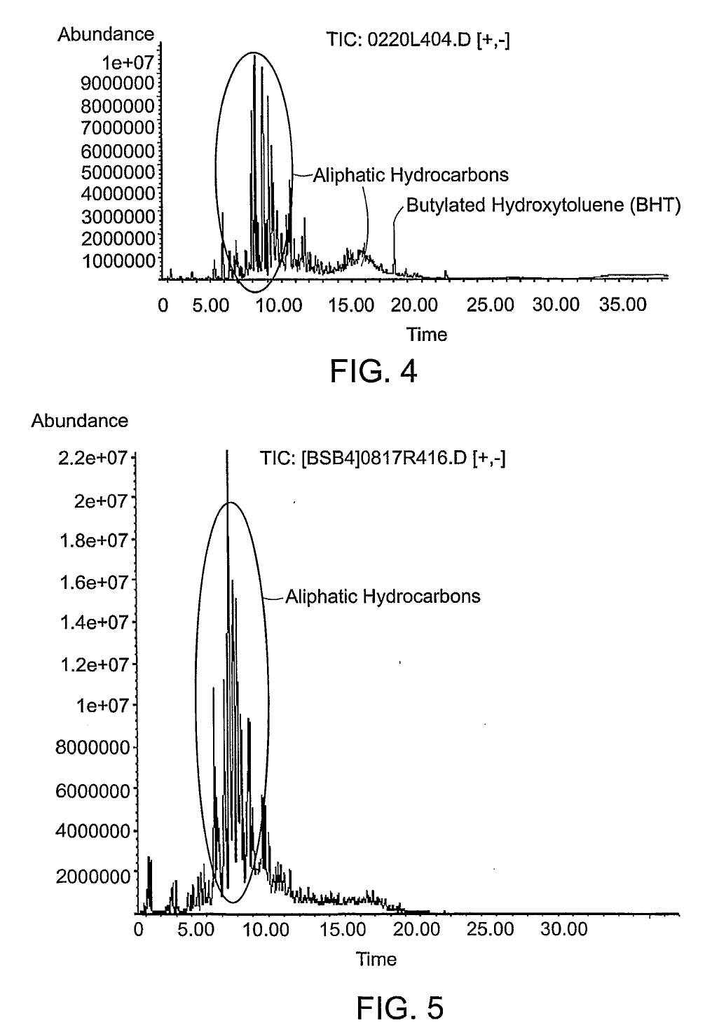

Testing of the polyethylene beads used for the potting material for the filters by desorption yields the GC/MS data shown in FIG. 4. The integrated desorbed species have a total content of about 3 μg/gm/min.

Table 1 presents more detailed specification information from an off-gassing filter unit test, configured to detect high boilers, conducted with a filter unit utilizing the polyethylene potting material. The result corresponds with a condition after a period of 24 hours of off-gassing occurring in the filter tunnel. Retention times are probabilistically matched with potential compounds from a NIST standard library. FIG. 5 presents the corresponding GC/MS graph.

TABLE 1
Speciation from GC/MS analysis of FIG. 5

| Retention | | NIST Library | Concentration, μg/m³ | |
|---|---|---|---|---|
| Time, min | Compound | Match, % | as toluene | as hexadecane |
| 1.89 | Toluene | 58 | 1.1 | 1.5 |
| 2.09 | Aliphatic Hydrocarbon | 58 | 2.9 | 3.8 |
| 2.19 | Aliphatic Hydrocarbon | 68 | 7.5 | 9.9 |
| 2.34 | Aliphatic Hydrocarbon | 91 | 6.5 | 8.6 |
| 2.7 | Aliphatic Hydrocarbon | 58 | 0.2 | 0.3 |
| 2.94 | Aliphatic Hydrocarbon | 50 | 0.3 | 0.4 |
| 3.34 | Aliphatic Hydrocarbon | 70 | 1.4 | 1.8 |
| 3.46 | Aliphatic Hydrocarbon | 59 | 1.1 | 1.5 |
| 3.64 | Unidentified Compound | — | 3.8 | 5.0 |
| 3.78 | Aliphatic Hydrocarbon | 47 | 4.4 | 5.8 |
| 4 | Aliphatic Hydrocarbon | 64 | 4.2 | 5.5 |
| 4.17 | Aliphatic Hydrocarbon | 72 | 0.8 | 1.1 |
| 4.39 | Aliphatic Hydrocarbon | 58 | 0.3 | 0.4 |
| 4.53 | Aliphatic Hydrocarbon | 70 | 0.4 | 0.6 |
| 4.76 | Aliphatic Hydrocarbon | 72 | 3.7 | 4.8 |
| 4.96 | Aliphatic Hydrocarbon | 59 | 2.4 | 3.1 |
| 5.1 | Aliphatic Hydrocarbon | 53 | 5.5 | 7.2 |
| 5.42 | Aliphatic Hydrocarbon | 76 | 8.6 | 11 |
| 5.59 | Aliphatic Hydrocarbon | 64 | 7.6 | 9.9 |
| 5.83 | Aliphatic Hydrocarbon | 52 | 8.4 | 11 |
| 5.99 | Decane | 83 | 3.1 | 4.0 |
| 6.11 | Aliphatic Hydrocarbon | 94 | 6.4 | 8.4 |
| 6.37 | Aliphatic Hydrocarbon | 46 | 5.0 | 6.5 |
| 6.51 | Aliphatic Hydrocarbon | 78 | 34 | 45 |
| 6.66 | Aliphatic Hydrocarbon | 78 | 17 | 22 |
| 6.73 | Aliphatic Hydrocarbon | 72 | 9.7 | 13 |
| 6.81 | Aliphatic Hydrocarbon | 72 | 11 | 15 |
| 6.92 | Aliphatic Hydrocarbon | 87 | 6.5 | 8.5 |
| 7.18 | Aliphatic Hydrocarbon | 50 | 44 | 58 |
| 7.28 | Aliphatic Hydrocarbon | 59 | 12 | 15 |
| 7.48 | Aliphatic Hydrocarbon | 50 | 101 | 133 |
| 7.71 | Aliphatic Hydrocarbon | 64 | 41 | 53 |
| 7.78 | Aliphatic Hydrocarbon | 53 | 53 | 70 |
| 8 | Aliphatic Hydrocarbon | 55 | 64 | 84 |
| 8.11 | Aliphatic Hydrocarbon | 64 | 13 | 17 |
| 8.24 | Undecane | 80 | 42 | 55 |
| 8.39 | Unidentified Compound | — | 15 | 19 |
| 8.54 | Aliphatic Hydrocarbon | 49 | 8.1 | 11 |
| 8.67 | Aliphatic Hydrocarbon | 50 | 30 | 39 |
| 8.78 | Aliphatic Hydrocarbon | 64 | 33 | 44 |
| 8.95 | Aliphatic Hydrocarbon | 59 | 20 | 26 |
| 9.05 | Aliphatic Hydrocarbon | 64 | 16 | 20 |
| 9.24 | Aliphatic Hydrocarbon | 64 | 6.5 | 8.5 |
| 9.29 | Aliphatic Hydrocarbon | 46 | 5.6 | 7.4 |
| 9.38 | Unidentified Compound | — | 5.0 | 6.5 |
| 9.48 | Aliphatic Hydrocarbon | 64 | 9.0 | 12 |
| 9.6 | Aliphatic Hydrocarbon | 64 | 22 | 29 |
| 9.75 | Aliphatic Hydrocarbon | 59 | 28 | 37 |
| 10.03 | Aliphatic Hydrocarbon | 58 | 17 | 22 |
| 10.31 | Aliphatic Hydrocarbon | 87 | 13 | 17 |
| 10.48 | Dodecane | 80 | 7.7 | 10 |
| 10.62 | Aliphatic Hydrocarbon | 86 | 9.4 | 12 |
| 10.81 | Aliphatic Hydrocarbon | 46 | 11 | 15 |
| 10.93 | Aliphatic Hydrocarbon | 64 | 4.0 | 5.3 |
| 11.01 | Aliphatic Hydrocarbon | 78 | 8.7 | 11 |
| 11.16 | Aliphatic Hydrocarbon | 46 | 3.2 | 4.2 |
| 11.39 | Aliphatic Hydrocarbon | 64 | 13 | 17 |
| 11.57 | Aliphatic Hydrocarbon | 58 | 6.2 | 8.1 |
| 11.84 | Aliphatic Hydrocarbon | 58 | 8.4 | 11 |
| 12.06 | Unidentified Compound | — | 4.6 | 6.1 |
| 12.17 | Aliphatic Hydrocarbon | 52 | 1.5 | 2.0 |
| 12.31 | Aliphatic Hydrocarbon | 64 | 3.4 | 4.4 |
| 12.41 | Aliphatic Hydrocarbon | 90 | 3.3 | 4.3 |
| 12.59 | Tridecane | 81 | 6.1 | 8.0 |
| 12.71 | Unidentified Compound | — | 2.3 | 3.0 |
| 12.83 | Cyclobutanone, 2-(1,1-dimethylethyl)- | 46 | 2.6 | 3.4 |
| 12.94 | Unidentified Compound | — | 4.8 | 6.3 |
| 13.1 | 1-Dodecanol, 3,7,11-trimethyl- | 58 | 4.6 | 6.1 |
| 13.37 | Cyclododecanol, 1-ethenyl- | 51 | 2.0 | 2.7 |
| 13.48 | Aliphatic Hydrocarbon | 43 | 3.2 | 4.2 |
| 13.66 | Aliphatic Hydrocarbon | 45 | 1.9 | 2.5 |
| 13.75 | Aliphatic Hydrocarbon | 47 | 3.2 | 4.3 |
| 13.87 | Unidentified Compound | — | 2.9 | 3.8 |
| 13.98 | Unidentified Compound | — | 1.9 | 2.4 |
| 14.09 | Unidentified Compound | — | 4.4 | 5.8 |
| 14.25 | Unidentified Compound | — | 2.5 | 3.2 |
| 14.39 | Unidentified Compound | — | 3.0 | 3.9 |
| 14.56 | Tetradecane | 70 | 4.1 | 5.3 |
| 14.93 | Aliphatic Hydrocarbon | 41 | 4.8 | 6.3 |
| 15.06 | Aliphatic Hydrocarbon | 64 | 1.5 | 2.0 |
| 15.25 | Aliphatic Hydrocarbon | 58 | 4.0 | 5.3 |
| 15.32 | Aliphatic Hydrocarbon | 49 | 1.7 | 2.2 |
| 15.5 | Aliphatic Hydrocarbon | 70 | 3.9 | 5.2 |
| 15.59 | Aliphatic Hydrocarbon | 49 | 2.6 | 3.4 |
| 15.74 | Aliphatic Hydrocarbon | 60 | 2.4 | 3.1 |
| 15.92 | Aliphatic Hydrocarbon | 41 | 3.6 | 4.7 |
| 16.08 | Aliphatic Hydrocarbon | 64 | 3.1 | 4.1 |
| 16.22 | Aliphatic Hydrocarbon | 58 | 4.6 | 6.0 |
| 16.46 | Aliphatic Hydrocarbon | 41 | 4.9 | 6.4 |
| 16.63 | Aliphatic Hydrocarbon | 91 | 4.7 | 6.2 |
| 16.87 | Aliphatic Hydrocarbon | 55 | 5.1 | 6.8 |
| 17.05 | Aliphatic Hydrocarbon | 46 | 2.2 | 2.9 |
| 17.17 | Unidentified Compound | — | 2.6 | 3.5 |
| 17.29 | Aliphatic Hydrocarbon | 64 | 2.6 | 3.4 |
| 17.41 | Aliphatic Hydrocarbon | 64 | 2.2 | 2.9 |
| 17.68 | Aliphatic Hydrocarbon | 70 | 4.6 | 6.0 |
| 17.91 | Aliphatic Hydrocarbon | 53 | 1.7 | 2.3 |
| 18.15 | Aliphatic Hydrocarbon | 50 | 1.8 | 2.3 |
| 18.42 | 2-Norbornanone | 50 | 0.8 | 1.0 |
| 18.61 | Unidentified Compound | — | 1.4 | 1.8 |
| 18.82 | Bicyclo[2.2.1]heptane-2-methanol | 50 | 0.5 | 0.6 |
| 18.9 | Aliphatic Hydrocarbon | 64 | 0.4 | 0.5 |
| 19.18 | Aliphatic Hydrocarbon | 68 | 0.2 | 0.3 |
| 19.25 | Aliphatic Hydrocarbon | 62 | 0.2 | 0.2 |
| | Total | | 962 | 1265 |

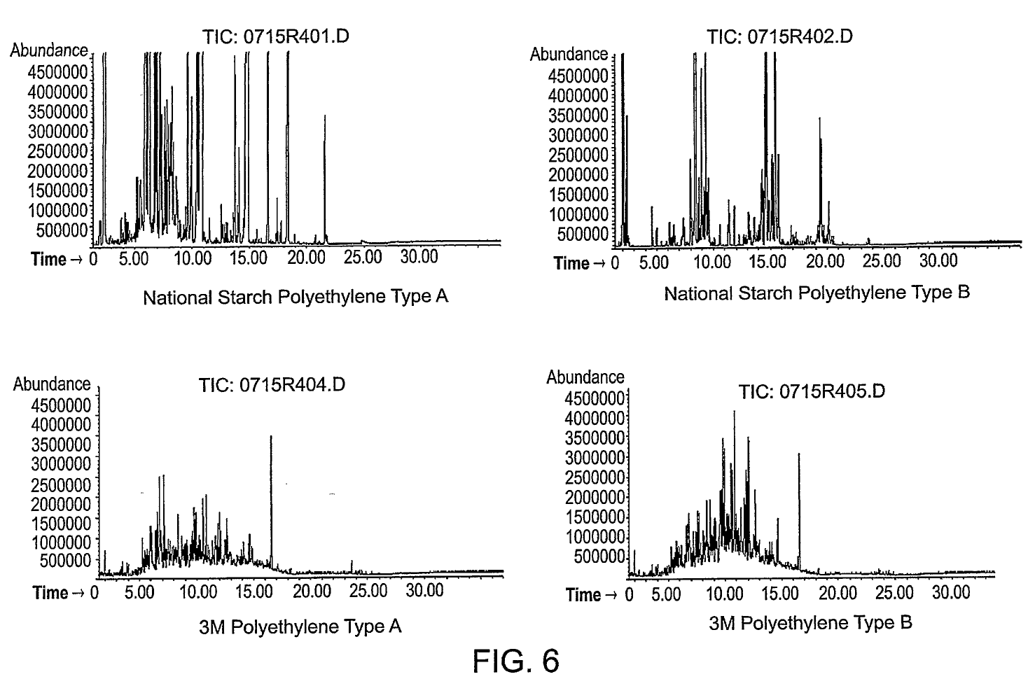

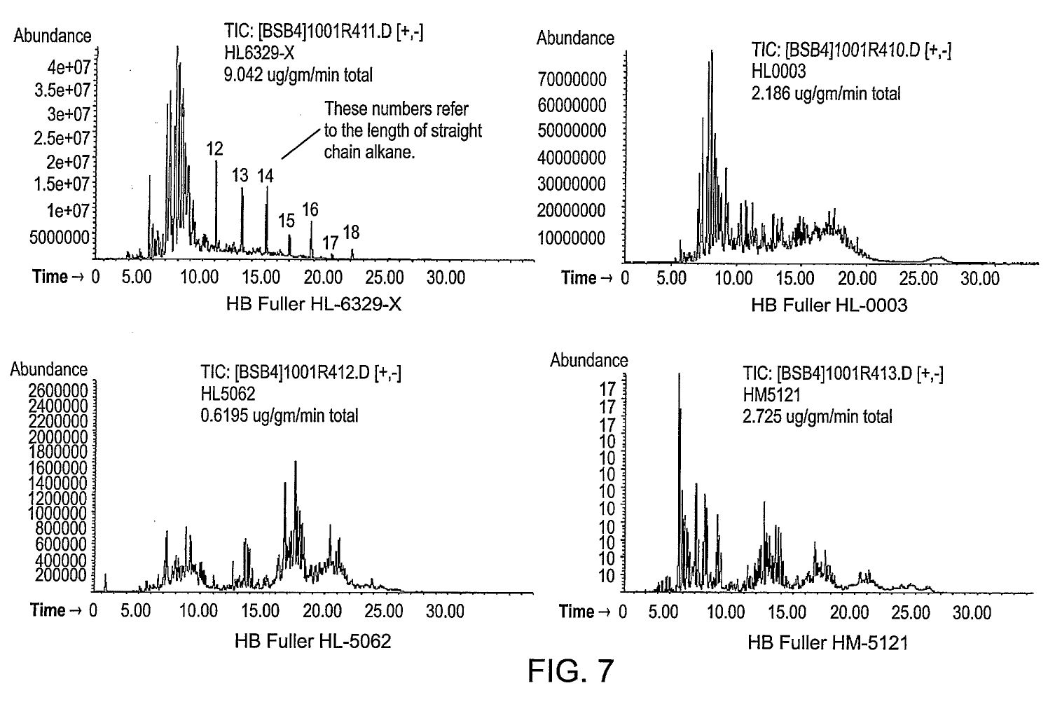

Desorption tests were also conducted on eight other commercially available polyethylene potting materials as shown in FIGS. 6 and 7. In each instance, a substantial amount of contaminants is present. Thus, none of the commercially available potting materials tested reach low levels of contamination.

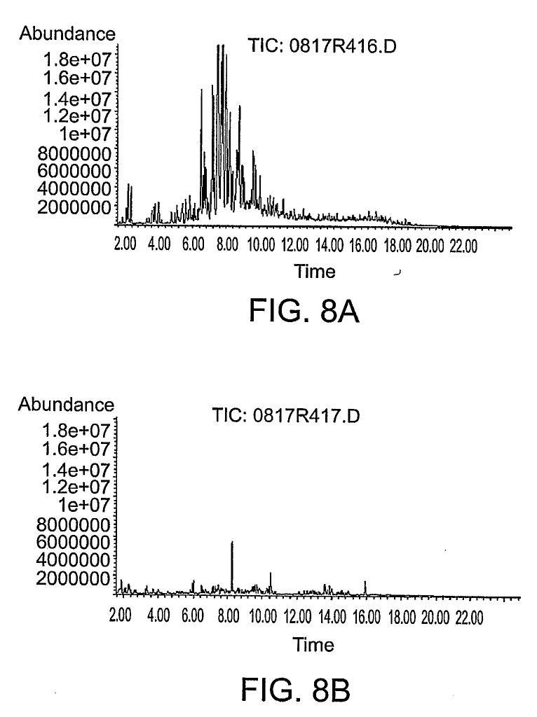

A new potting material, designated S1, provides essentially lower amounts of contamination in an off-gassing filter units test relative to a standard polyethylene potting material. S1 is a polyurethane substrate with carbon black that has reduced aliphatic hydrocarbons, but still contains traces of siloxanes, HMDSO, and BHT. As depicted in the GC/MS results configured to detect high boilers, shown in FIGS. 8A and 8B, the standard polyethylene potting material shows much higher levels of off-gassing contamination, both of individual species and total integrated contaminants detected (FIG. 8A) relative the filter using potting material made from S1 (FIG. 8B).

Using a low boiler detection arrangement to capture contaminants, however, yields a much larger integrated signal of contaminants and the presence of silicon-containing species. Table 2 shows the contaminants found progressively on each of 3 days in which the off-gassing filter units test was performed on a filter unit utilizing S1 as a potting material. Two filter units were tested using S1, designated as tests conducted in Tunnel A and Tunnel B.

TABLE 2
Summary of Low Boiler Detection Configuration Results of S1

| | | Day 1 | Day 2 | Day 3 |
|---|---|---|---|---|
| Total Contaminants | Tunnel A | 1763 | 1288 | 1001 |
| (μg/m³) | Tunnel B | 2054 | 1243 | 1272 |
| Total Low Boilers | Tunnel A | 1679 | 1266 | 935 |
| (μg/m³) | Tunnel B | 1914 | 1210 | 1191 |
| Total High Boilers | Tunnel A | 83.1 | 22 | 66 |
| (μg/m³) | Tunnel B | 136 | 30.3 | 79 |
| TMS | Tunnel A | 0.18 | Not detected | Not detected |
| | Tunnel B | 0.4 | Not detected | 0.23 |
| HMDSO | Tunnel A | 0.48 | Not detected | 0.21 |
| | Tunnel B | 0.15 | Not detected | Not detected |
| Isobutoxytrimethyl | Tunnel A | 0.16 | Not detected | Not detected |
| silane | Tunnel B | Not | Not detected | Not detected |
| | | detected | | |
| Hexamethyl | Tunnel A | Not | 0.04 | 0.04 |
| | | detected | | |
| cyclotrisiloxane | Tunnel B | 0.025 | 0.09 | 0.039 |

As shown in Table 2, the low boiler test shows a much larger signal than the high boiler test in terms of total integrated signal corresponding with total contaminants detected. The low boiler arrangement also yielded the presence of HMDSO, silanes, and siloxanes; a result that was not found in the high boiler arrangement. The result indicated that S1 still contained the presence of silicon-containing species that needed removal.

A new potting material, S2, was created. S2 contains a polyurethane substrate with carbon black. The monolithic polyurethane substrate S2 (i.e., not foamed) was created free of HMDSO, silanes, siloxanes, and BHT. Desorption tests were performed on samples of S2, both using the high boiler detection arrangement and the low boiler detection arrangement. Table 3 presents the high boiler detection arrangement results, while Table 4 presents the low detection results.

TABLE 3
Results for Desorption Test Optimized for High Boiler Detection
Using Sample S2
Key Polymer PC3793 B/A (Si-Free) HIGH BOILER RESULTS

| | | NIST | Off Gas Rate, | |
|---|---|---|---|---|
| Retention | | Library | ug/gm/min | |
| Time, min | Compound | Match, % | as toluene | CAS# |
| 16.32 | Aliphatic | 40 | 0.0008 | — |
| | Hydrocarbon | | | |
| 16.89 | Butylated | 86 | 0.0018 | 128-37-0 |
| | Hydroxytoluene | | | |
| | (BHT) | | | |
| | Total | | 0.0026 | |

TABLE 4
Results for Desorption Test Optimized for Low Boiler Detection Using
Sample S2
Key Polymer PC3793 B/A (Si-Free) LOW BOILER RESULTS

| | | NIST | Off Gas | |
|---|---|---|---|---|
| | | Library | Rate, | |
| Retention | | Match, | ug/gm/min | |
| Time, min | Compound | % | as toluene | CAS# |
| 4.1 | Unidentified Compound | — | 0.0001 | — |
| 6.6 | Unidentified Compound | — | 0.0008 | — |
| 19.79 | Unidentified Compound | — | 0.0001 | — |
| 21.7 | Benzene, chloro- | 91 | 0.0005 | 108-90-7 |
| 23.1 | Unidentified Compound | — | 0.0002 | — |
| 26.27 | Unidentified Compound | — | 0.0001 | — |
| 26.69 | Aliphatic Hydrocarbon | 64 | 0.0002 | — |
| 26.87 | Aliphatic Hydrocarbon | 72 | 0.0001 | — |
| 27.45 | Unidentified Compound | — | 0.0002 | — |
| 27.93 | Unidentified Compound | — | 0.0001 | — |
| 33.58 | Unidentified Compound | — | 0.0001 | — |
| 33.97 | Phenol, 4- | 50 | 0.0001 | 91680-55-6 |
| | (2-thienylmethyl)- | | | |
| 34.51 | Unidentified Compound | — | 0.0001 | — |
| 37.01 | Unidentified Compound | — | 0.0001 | — |
| 37.5 | Unidentified Compound | — | 0.0019 | — |
| | Total | | 0.0046 | |

Both the high boiler and low boiler results show a small total amounts of contaminants. The results also do not show the presence of silicon-containing species within the detection limit of the test.

Another polyurethane substrate S3 was manufactured, the substrate being foamed to decrease the total amount of material used. Table 5 summarizes the properties of the component polyurethanes and complete mixture that forms S3; S3 being formed with 2 parts component B to 1 part component A by volume (or 100 parts component B to 45 parts component A by weight). S3, like S2, was created free of HMDSO, silanes, siloxanes, and BHT. Testing with S3 in off-gassing filter unit tests showed favorable off-gassing characteristics similar to those for S2.

TABLE 5
Summary of Properties of Polyurethane S3

| | Component A | Component B | Mixture |
|---|---|---|---|
| Color | Black | Amber | Black |
| Viscosity at 25° C. | 65,000 cPs | 150 cPs | 25,000 cPs |
| Brookfield RVT | #6 at 10 rpm | #1 at 10 rpm | #6 at 10 rpm |
| Thixotropic Index | 5.0 | 1.0 | 4.0 |
| (1 ÷ 10) | | | |
| Specific Gravity | 1.39 | 1.23 | 0.50 (foamed) |
| Density (lbs/gal) | 11.5 | 10.3 | 4.2 (foamed) |

While this invention has been particularly shown and described with references to preferred embodiments thereof, it will be understood by those skilled in the art that various changes in form and details may be made therein without departing from the scope of the invention encompassed by the appended claims.

What is claimed is:

1. A low off-gassing polyurethane comprising:
a polyurethane substrate;
additive being essentially free of off-gassing silicon-containing contaminants;
wherein the low off-gassing polyurethane substrate is suitable for use in environments where off-gassing contaminants are detrimental.

2. The polyurethane of claim 1 wherein the polyurethane substrate is essentially free of non-silicon off-gassing producing contaminants.

3. The polyurethane of claim 2 wherein the polyurethane substrate is essentially free of aliphatic hydrocarbons, butylated hydroxytoluene (BHT), particular phthalates (e.g., dioctyl phthalate (DOP), dibutyl phthalatae (DBP), diethyl phthalate (DEP)), chlorine organics, and volatile organic acids and bases.

4. The polyurethane of claim 1, wherein the polyurethane substrate is foamed.

5. The polyurethane of claim 1, wherein the polyurethane substrate emits one or more silicon-containing contaminants at a rate below about 0.0001 μg/gm/min when the substrate is subjected to a temperature of about 50° C. for about 30 minutes at about atmospheric pressure.

6. The polyurethane of claim 1 wherein the condensable organic level is
a) below 0.9 μg/m³; or
b) below 0.35 μg/m³.

7. (canceled)

8. The polyurethane of claim 1, wherein the level of phthalates (DOP, DBP, DEP), BHT and chlorine organics are below 0.2 μg/m³.

9. The polyurethane of claim 1, wherein the level of volatile organic bases is
a) below 0.2 μg/m³; or
b) below 0.07 μg/m³.

10. (canceled)

11. The polyurethane of claim 1, wherein the level of volatile organic acids is below the range of 0.4 μg/m³ to 0.03 μg/m³.

12. The polyurethane of claim 1 further comprising carbon black.

13. A potting material comprising:
a low off-gassing polyurethane substrate being essentially free of silicon-containing contaminants;
wherein the low off-gassing polyurethane substrate is suitable for use in environments where off-gassing contaminants are detrimental.

14. The potting material of claim 13, wherein the polyurethane substrate is essentially free of non-silicon off-gassing producing contaminants.

15. The potting material of claim 13, wherein the polyurethane substrate is essentially free of aliphatic hydrocarbons, butylated hydroxytoluene (BHT), particular phthalates (e.g., dioctyl phthalate (DOP), dibutyl phthalatae (DBP), diethyl phthalate (DEP)), chlorine organics, and volatile organic acids and bases.

16. The potting material of any one of claim 13, wherein the polyurethane substrate is foamed.

17. The potting material of any one of claim 13, wherein the polyurethane substrate emits silicon-containing contaminants at a rate below 0.0001 μg/gm/min when the substrate is subjected to a temperature of about 50° C. for about 30 minutes at about atmospheric pressure.

18-23. (canceled)

24. A filter unit comprising:
a filter membrane;
a filter frame; and
a potting material attaching the filter membrane to the filter frame, the potting material comprising a low off-gassing polyurethane substrate being essentially free of silicon-containing contaminants;
wherein the low off-gassing polyurethane substrate is suitable for use in environments where off-gassing contaminants are detrimental.

25. The filter unit of claim 24, wherein the polyurethane substrate is essentially free of non-silicon off-gassing producing contaminants.

26. The filter unit of claim 24, wherein the polyurethane substrate is essentially free of aliphatic hydrocarbons, butylated hydroxytoluene (BHT), particular phthalates (e.g., dioctyl phthalate (DOP), dibutyl phthalatae (DBP), diethyl phthalate (DEP)), chlorine organics, and volatile organic acids and bases.

27. The filter unit of claim 24, wherein the polyurethane substrate is foamed.

28. The filter unit of claim 24, wherein the polyurethane substrate emits silicon-containing contaminants at a rate below 0.0001 μg/gm/min when the substrate is subjected to a temperature of about 50° C. for about 30 minutes at about atmospheric pressure.

29-34. (canceled)
